(19) United States
(12) Patent Application Publication
(10) Pub. No.: US 2016/0198459 A1
(43) Pub. Date: Jul. 7, 2016

(54) COMMUNICATION METHOD AND APPARATUS USING SLOT BASED CHANNEL

(71) Applicant: AJOU UNIVERSITY INDUSTRY-ACADEMIC COOPERATION FOUNDATION, Suwon-si (KR)

(72) Inventors: Hong Jun NOH, Suwon-si (KR); Jae Sung LIM, Suwon-si (KR); Ho Ki BAEK, Suwon-si (KR)

(73) Assignee: AJOU UNIVERSITY INDUSTRY-ACADEMIC COOPERATION FOUNDATION, Suwon-si (KR)

(21) Appl. No.: 14/725,783

(22) Filed: May 29, 2015

(30) Foreign Application Priority Data
Jan. 5, 2015 (KR) 10-2015-0000705

(51) Int. Cl. H04W 72/04; H04W 28/06; H04W 72/08

(52) U.S. Cl. CPC H04W 72/0446; H04W 72/082; H04W 28/06

(57) ABSTRACT

The present invention generally relates to a communication method and apparatus using a slot-based channel and, more particularly, to technology for estimating slot-based channel values in real time so as to perform Analog Network Coding (ANC) or full-duplex communication in a single slot. In order to achieve the object, a communication apparatus using a slot-based channel according to an embodiment includes a transmission unit, a channel estimation unit, and a decoding unit.

### CROSS-REFERENCE TO RELATED APPLICATIONS

This application claims the benefit of priority of Korean Application No. 10-2015-0000705, filed Jan. 5, 2015, in the Korean Intellectual Property Office. The disclosure of the document named above is incorporated herein by reference.

### BACKGROUND OF THE INVENTION

1. Field of the Invention

The present invention generally relates to a communication method and apparatus using a slot-based channel and, more particularly, to technology for estimating slot-based channel values in real time so as to perform Analog Network Coding (ANC) or full-duplex communication in a single slot.

2. Description of the Related Art

Recently, research into full-duplex communication using a single channel has been actively conducted. Conventional single channel communication makes it impossible for two terminals to simultaneously transmit signals through a single channel due to channel interference. Core technology for implementing full-duplex communication using a single channel is that a terminal immediately eliminates a signal, transmitted through its own transmitter, from a received signal at its own receiver. By means of this, it may be theoretically predicted that communication in a single channel, which was operated in half-duplex communication mode in the past, may be extended to full-duplex communication. Further, recently, in consideration of such a trend, an interference cancellation technique for single channel full-duplex communication has been proposed. In full-duplex communication, channel values must be estimated to perform interference cancellation, similar to analog network coding (ANC).

Meanwhile, in a recent two-way relay system, an ANC technique for increasing throughput up to double the existing throughput has been proposed. ANC is configured such that two terminals simultaneously transmit different pieces of information in a single frequency band and a single time slot through a relay, and receive an overlapping signal through the relay. The core of the above-described ANC technology may be regarded as Interference Cancellation (IC) technique for allowing a certain terminal to recover a received signal by eliminating a signal transmitted thereby from an overlapping received signal. Such an IC technique may be used independent of modulation technique or channel coding. To perform the IC technique that is the core technology of ANC, channel values (frequency offset, phase offset, and amplitude offset) of a signal to be eliminated must be estimated. That is, to perform the IC technique in ANC and full-duplex communication, channel values must be estimated, wherein the channel values vary with time and a non-overlapping signal is required to analyze channel values.

Further, a large number of systems are currently operated based on Time Division Multiple Access (TDMA). Such a TDMA-based system aims to maintain time synchronization as exact as possible to reduce a guard time. Therefore, when the TDMA-based system performs ANC or full-duplex communication, wide areas of two signals overlap each other. In this case, channel values must be estimated using an overlapping signal, which results in the following disadvantages: precision is greatly deteriorated compared to the case where channel values are estimated using a non-overlapping signal, and performance of interference cancellation is also deteriorated due to imprecise channel values. Further, there is a disadvantage in that an additional channel or time is required to estimate channel values separately from an overlapping transmission channel so as to perform ANC and full-duplex communication.

Meanwhile, Korean Patent No. 10-1301298 entitled “RF Relay of Full-Duplex and Method for Reducing Interference of Electromagnetic (EM)-Level thereof” presents an EM-level interference cancellation method. That is, the EM-level interference cancellation method is a method of eliminating an EM-level interference signal received through an interference channel in a full-duplex RF relay for relaying RF signals between a base station and a terminal. The method includes the step of estimating a modulation/demodulation channel between an interference channel, the base station, and the RF relay, and between the RF replay and the terminal; the step of generating a transformation matrix so that the transformation matrix utilizes estimated values of the modulation/demodulation channel and the interference channel, optimizes a given objective function, satisfies a power limit condition, and belongs to a null space of the channel matrix of the interference channel; the step of converting a received signal using the transformation matrix and generating a transmission signal; and the step of transmitting the transmission signal, wherein the objective function includes at least one of mutual information between the terminal and the base station, Signal-to-Interference plus Noise Ratio (SINR) of the terminal, a mean square error between the transmission signal of the base station and the received signal of the terminal, and a bit error rate between the transmission signal of the base station and the received signal of the terminal.

In the preceding technology, a transmission signal is designed so that an EM-level interference signal produced by the transmitting antenna of a full-duplex RF relay is not received through a receiving antenna. Accordingly, there is an advantage in that an EM-level interference signal may be cancelled or minimized, thus optimizing the performance of the RF relay. However, the preceding technology is disadvantageous in that, upon estimating channels, a modulation/demodulation channel and an interference channel are estimated using a pilot signal, in other words, the interference channel for full-duplex communication is acquired separately from the modulation/demodulation channel required for communication, so that an additional channel and time are required as in the case of the conventional technology. Further, since the above preceding technology does not consider the characteristics of a TDMA-based system that intends to maintain time synchronization as exact as possible, a problem arises in that, when this technology is applied to the TDMA-based system, channel values must be estimated from an overlapping signal in which wide areas of signals overlap each other, thus greatly deteriorating the precision of estimated channel values and also decreasing the performance of interference cancellation.

### PRIOR ART DOCUMENTS

### Patent Documents

(Patent Document 1) Korean Patent No. 10-1301298 (Date of Registration: Aug. 22, 2013)

### SUMMARY OF THE INVENTION

The present invention relates to a communication method and apparatus using a slot-based channel and an object of the present invention is to provide technology for estimating slot-based channel values in real time so as to perform Analog Network Coding (ANC) or full-duplex communication in a single slot.

Another object of the present invention is to propose a full-duplex communication scheme and protocol, which can guarantee high channel usage efficiency when applied to a satellite positioning/communication convergence system.

A further object of the present invention is to propose a communication scheme and protocol, which can estimate precise channel values by receiving transmitted packets so that start and end portions of the transmitted packets do not overlap each other.

Yet another object of the present invention is to provide analog network coding and full-duplex communication technology, which can be applied to a system requiring exact time synchronization as in the case of a TDMA-based system.

Still another object of the present invention is to provide channel acquisition technology, which enables analog network coding and full-duplex communication in a single channel, without requiring an additional channel for channel value acquisition.

Still another object of the present invention is to estimate precise channel values in real time by applying a single protocol to different channel environments including a two-way relay channel, such as for analog network coding, and a single channel for full-duplex communication, without any protocol correction.

In order to accomplish the above objects, a communication apparatus using a slot-based channel according to an embodiment of the present invention includes a processor. The processor may include a transmission unit, a channel estimation unit, and a decoding unit as sub-modules.

The transmission unit transmits a first data packet that is desired to be transmitted from a first terminal station to a second terminal station in a slot, the channel estimation unit estimates characteristic values of a channel based on the slot using part of the first data packet, and the decoding unit applies the characteristic values of the slot-based channel and an interference cancellation technique based on the first data packet to a signal received by the first terminal station in the slot, and then decodes, from the received signal, a second data packet that is transmitted from the second terminal station.

Further, the channel estimation unit may estimate the characteristic values of the slot-based channel using part of the first data packet that is exclusively transmitted in the slot. The transmission unit may be configured to, in order for the first terminal station to receive the part of the first data packet without interference, transmit the first data packet earlier or later than the second data packet that is transmitted from the second terminal station.

Furthermore, the transmission unit may be configured to, in order for the first terminal station to receive the part of the first data packet without interference, transmit the first data packet, with a payload size of the first data packet being reduced, and may reduce the payload size of the first data packet by an amount corresponding to a sum of a preamble size and a guard time, and transmit the first data packet, with a time synchronization error value being included in the size-reduced payload. Further, the transmission unit may transmit the first data packet earlier or later than the second data packet that is transmitted from the second terminal station, by a time corresponding to the reduced payload size of the first data packet from a slot boundary, and may generate the part of the first data packet using a spreading code (pseudo random noise code).

In addition, a communication method using a slot-based channel according to an embodiment of the present invention includes transmitting a first data packet that is desired to be transmitted from a first terminal station to a second terminal station in a slot, estimating characteristic values of a channel based on the slot using part of the first data packet, and applying the characteristic values of the slot-based channel and an interference cancellation technique based on the first data packet to a signal received by the first terminal station in the slot, and then decoding, from the received signal, a second data packet that is transmitted from the second terminal station.

Further, estimating the characteristic values of the channel may include estimating the characteristic values of the slot-based channel using part of the first data packet that is exclusively transmitted in the slot, and transmitting the first data packet may include, in order for the first terminal station to receive the part of the first data packet without interference, transmitting the first data packet earlier or later than the second data packet that is transmitted from the second terminal station.

Furthermore, transmitting the first data packet may include, in order for the first terminal station to receive the part of the first data packet without interference, transmitting the first data packet, with a payload size of the first data packet being reduced, include reducing the payload size of the first data packet by an amount corresponding to a sum of a preamble size and a guard time, and transmitting the first data packet, with a time synchronization error value being included in the size-reduced payload, include transmitting the first data packet earlier or later than the second data packet that is transmitted from the second terminal station, by a time corresponding to the reduced payload size of the first data packet from a slot boundary, and include generating the part of the first data packet using a spreading code (pseudo random noise code).

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a diagram showing an example of packet transmission according to an embodiment of the present invention;

FIG. 2 is a schematic configuration diagram of a communication apparatus using a slot-based channel according to an embodiment of the present invention;

FIG. 3 is a conceptual diagram showing analog network coding to which communication technology using a slot-based channel according to an embodiment of the present invention can be applied;

FIG. 4 is a conceptual diagram showing full-duplex communication to which communication technology using a slot-based channel according to an embodiment of the present invention can be applied; and

FIG. 5 is an operation flowchart showing a communication method using a slot-based channel according to an embodiment of the present invention.

### DETAILED DESCRIPTION OF THE EMBODIMENTS

Hereinafter, embodiments of the present invention will be described in detail with reference to the accompanying drawings. In the following description, detailed descriptions of known elements or functions that may unnecessarily make the gist of the present invention obscure will be omitted. Further, in the description of the following embodiments of the present invention, detailed numerals merely indicate exemplary values.

The present invention generally relates to a communication method and apparatus using a slot-based channel and, more particularly, to technology for estimating slot-based channel values in real time so as to perform analog network coding or full-duplex communication in a single slot.

That is, the present invention is a technology that can be applied to different channel environments for analog network coding (applied to a two-way relay channel, wherein an uplink channel and a downlink channel are separated with respect to a relay) and for full-duplex communication (wherein a relay is not present and information is exchanged through a single channel without distinction of links).

First, the basic concept of the present invention will be described in brief and the present invention will be described in detail later. The present invention uses a method of reducing the size of the payload of a data packet that is transmitted (reduced payload size) and of delaying and transmitting a data packet (delayed transmission) to provide the communication method and apparatus using a slot-based channel.

Here, the term “reduced payload size” denotes the reduction of the size of the payload of a packet that is transmitted by a predetermined size (corresponding to the sum of a preamble size and a guard time in an embodiment of the present invention). Here, the reduced payload size must be long enough to acquire channel values, and must include a time synchronization error value. Since such a reduced size value differs depending on the characteristics of the system, it is not limited to a specific time in the present invention.

Further, the term “delayed transmission” denotes delaying (or advancing) one of two packets, respectively transmitted from two terminals, from a slot boundary by a time corresponding to the reduced payload size, and then transmitting the delayed (or advanced) packet. In this case, in the present invention, which one of the two terminals will be used to perform delayed transmission or advanced transmission may be determined before ANC or full-duplex communication is performed.

As described above, the present invention may transmit packets using a reduced payload size scheme and a delayed transmission scheme, thus enabling the transmitted data packets to be received without the start and end portions of the data packets overlapping each other, and allowing slot-based channel values intended by the present invention to be estimated via the start and end portions of the transmitted data packets.

Further, in the present invention, the start and end portions of each transmitted data packet include a spreading code having a specific pattern (corresponding to a Pseudo-Noise (PN) code or a pseudo random noise code) for improving estimation performance for slot-based channel values. A data packet transmitted according to the present invention is composed of a spreading code and a size-reduced payload, and slot-based channel values may be estimated using the spreading code present in the start and end portions of a transmitted data packet.

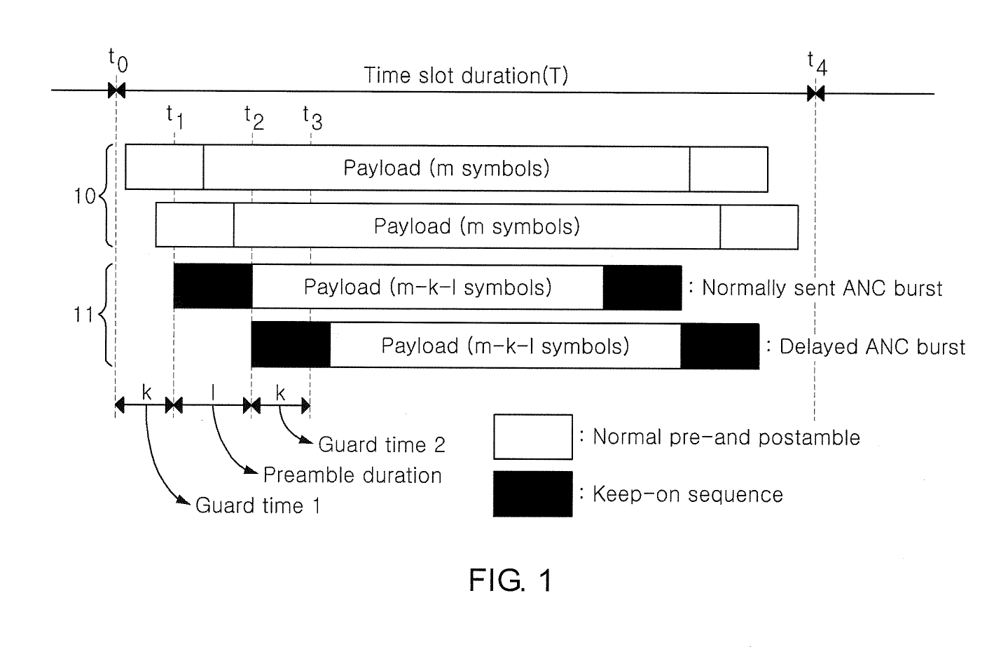

FIG. 1 is a diagram showing an example of packet transmission according to an embodiment of the present invention.

In FIG. 1, although an example applied to analog network coding is described as the example of packet transmission according to the embodiment of the present invention, it may also be equally applied to full-duplex communication, as well as to analog network coding.

Referring to FIG. 1, the example of packet transmission in a time slot when a reduced payload size and delayed transmission proposed in the present invention are utilized is illustrated. In FIG. 1, a guard time and a preamble are implemented as a duration denoted by k symbols and a duration denoted by l symbols, respectively. Accordingly, when the size of the payload of an existing packet is composed of m symbols, the size of the payload of a packet (i.e. a packet having a reduced payload size [length] proposed in the present invention) that is transmitted for ANC or full-duplex communication in the present invention is composed of m-k-l symbols.

That is, referring to FIG. 1, it can be seen that the payload size of the present invention (i.e. the payload size of m-k-l symbols shown in packets 11) becomes less than the conventional payload size (the payload size of m symbols shown in packets 10) and that respective payloads are transmitted without the start and end portions (i.e. a spreading code portion, a PN code portion, or a keep-on sequence portion) of the respective payloads overlapping each other.

In other words, packets 10 illustrate an example of packet overlapping when existing packets are transmitted. It can be seen that, when two packets are transmitted in the same slot, an overlapping portion between the two packets is considerably wide, thus causing interference even with preambles and postambles. Accordingly, packets 10 are disadvantageous in that channel values must be estimated via a separate channel in order to perform interference cancellation.

In contrast, packets 11 illustrate an example of packet transmission according to the resent invention. It can be seen that a single packet is delayed and transmitted, so that the preamble of a previously transmitted ANC packet (i.e. a packet transmitted for ANC or full-duplex communication) and the postamble of a subsequently transmitted ANC packet are respectively received without interference.

By means of this, the present invention is configured such that, when packets for ANC or full-duplex communication are transmitted, the start and end portions (i.e. preamble and postamble portions, spreading code portions, PN code portions, or keep-on sequence portions shown in FIG. 1) of data packets transmitted from two terminals (i.e. a first data packet and a second data packet that are data packets transmitted from a first terminal station and a second terminal station in the present invention) may be received without causing interference (collision). Via such a configuration, it is possible to estimate slot-based channel values required to perform ANC or full-duplex communication in a single slot in real time.

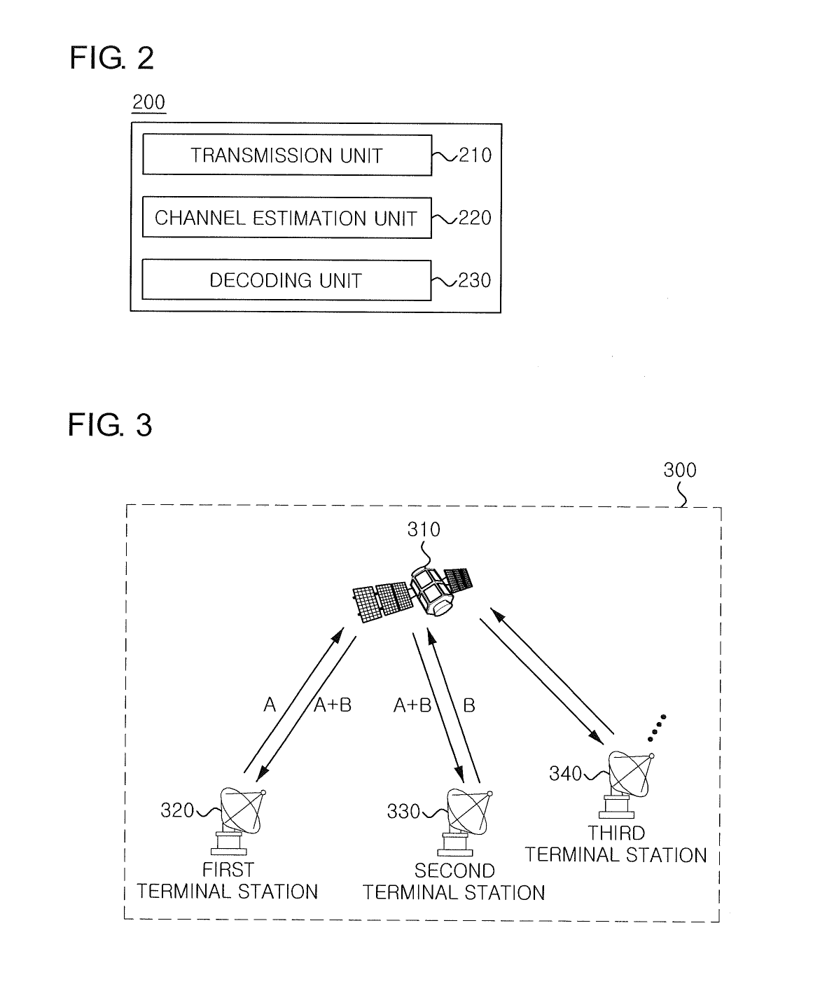

FIG. 2 is a schematic configuration diagram of a communication apparatus using a slot-based channel according to an embodiment of the present invention.

Prior to description, it is noted that, in order to perform ANC or full-duplex communication in a single slot, the present invention estimates channel values in the slot in real time using part of each data packet (i.e. a spreading code), and performs interference cancellation using the estimated channel values.

That is, in the present invention, all of a slot in which the first terminal station transmits a data packet to the second terminal station, a slot in which the characteristic values of a channel are estimated using part of a data packet, a slot in which the second terminal station transmits a data packet to the first terminal station, and a slot in which the first terminal station receives an overlapping signal of the first data packet and the second data packet represent a single identical slot. The present invention provides communication technology using a slot-based channel in which the transmission of a data packet, the estimation of channel characteristic values, and decoding are performed in a single slot.

Referring to FIG. 2, a communication apparatus 200 using a slot-based channel according to an embodiment of the present invention includes a transmission unit 210, a channel estimation unit 220, and a decoding unit 230.

The transmission unit 210 transmits a first data packet that is desired to be transmitted from the first terminal station to the second terminal station in a slot. Here, the first data packet is a packet to which the technology of the present invention (i.e. technology related to reduced payload size and delayed transmission) is applied, and indicates a packet including a spreading code and a size-reduced payload.

Further, the transmission unit 210 may generate part of the first data packet using a spreading code (corresponding to a PN code or a pseudo random noise code), and transmit a first data packet including the spreading code and the size-reduced payload to the second terminal station.

The channel estimation unit 220 estimates characteristic values of a channel based on the slot (i.e. slot in which the first data packet is transmitted via the transmission unit 210 to the first data packet) using the part of the first data packet. Here, the part of the first data packet denotes a spreading code portion included in the start and end portions of the first data packet (corresponding to a preamble and postamble portion, a PN code portion, or a keep-on sequence portion shown in FIG. 1), and the characteristic values of the slot-based channel may be estimated using the spreading code.

The decoding unit 230 applies the characteristic values of the slot-based channel and an interference cancellation technique based on the first data packet to a signal received by the first terminal station in the slot (i.e. the slot in which the first data packet is transmitted via the transmission unit 210), and then decodes a second data packet, which is transmitted from the second terminal station, from the received signal.

In other words, in the present invention, the first terminal station receives the signal transmitted from the second terminal station in the slot in which the first data packet has been transmitted via the transmission unit 210. At this time, the first terminal station receives an overlapping signal in which the signal transmitted thereby (i.e. the first data packet) and the signal transmitted from the second terminal station (i.e. the second data packet) overlap each other (the present invention may further include a reception unit (not shown) for allowing the first terminal station to receive the overlapping signal). Further, the decoding unit 230 may utilize the characteristic values of the slot-based channel estimated by the channel estimation unit 220 so as to perform interference cancellation in full-duplex communication or ANC, and may perform interference cancellation using the first data packet including a spreading code and a payload, especially using the payload. In this case, interference cancellation may be performed either using the entire portion of the first data packet (i.e. the spreading code and the payload portion), or using only the payload portion of the first data packet. Accordingly, the decoding unit 230 may decode the second data packet, transmitted from the second terminal station, from the signal that is received in the slot (i.e. the overlapping signal in which the signal transmitted from the first terminal station and the signal transmitted from the second terminal station overlap each other).

Further, when the decoding unit 230 cancels interference, the present invention may receive spreading codes (or preambles and postambles, or PN codes) required to estimate channel values of the transmitted two packets without overlapping (i.e. interference), estimate more precise channel values, and then expect further improved performance for interference cancellation, unlike the disadvantage of conventional packet transmission in that an overlapping portion between two packets is considerably wide and then the precision of channel estimation is deteriorated and the performance of interference cancellation is also decreased.

Further, the channel estimation unit 220 may estimate the characteristic values of the slot-based channel using part (i.e. a spreading code portion) of the first data packet that is exclusively transmitted (without overlapping or interference) in the slot.

Furthermore, the transmission unit 210 is configured to, when the first terminal station transmits a desired first data packet to the second terminal station in the slot, transmit the first data packet earlier or later than (delayed transmission) the second data packet that is transmitted from the second terminal station, in order for the first terminal station to receive part of the first data packet (spreading code portion) without interference. That is, this technology refers to a delayed transmission technology proposed in the present invention.

Also, upon transmitting the first data packet, the transmission unit 210 may transmit the first data packet earlier or later than the second data packet, transmitted from the second terminal station, by a time corresponding to the reduced payload size of the first data packet from a slot boundary.

In this case, the transmission unit 210 may determine which one of the first terminal station and the second terminal station will transmit a data packet later or earlier before ANC or full-duplex communication is performed. This may also be determined according to the preset sequence.

Further, the transmission unit 210 may transmit the first data packet, with the payload size of the first data packet being reduced, in order for the first terminal station to receive the part of the first data packet (spreading code portion) without interference. That is, it means a reduced payload size technology proposed in the present invention.

Furthermore, the transmission unit 210 may reduce the payload size of the first data packet by an amount corresponding to the sum of a preamble size and a guard time, and may transmit the first data packet, with a time synchronization error value being included in the size-reduced payload of the first data packet, wherein the reduced payload size of the first data packet may be a size of m-k-l symbols, as described above with reference to FIG. 1.

Hereinafter, the concept of analog network coding and full-duplex communication to which the present invention can be applied will be described in brief.

FIG. 3 is a conceptual diagram showing analog network coding to which communication technology using a slot-based channel according to an embodiment of the present invention can be applied.

In FIG. 3, although analog network coding according to the present invention has been described using a satellite network 300 as an embodiment, the application examples of the present invention are not limited to the satellite network 300. For convenience of description, the satellite network 300 such as that shown in FIG. 3 is illustrated. The analog network coding of the present invention can also be applied to a two-way relay communication network in addition to the satellite network 300.

Referring to FIG. 3, a scheme for communication technology using a slot-based channel, to which analog network coding according to an embodiment of the present invention is applied, may include a satellite network 300, a satellite 310, and one or more terminal stations 320, 330, and 340.

Here, each of the terminal stations 320, 330, and 340 may be a concept including one or more of a communication terminal/communication device such as a mobile phone, a transmission/reception device installed on a ship or a vehicle, and a satellite signal receiver.

It can be seen from FIG. 3 that the first terminal station 320 and the second terminal station 330 perform communication based on analog network coding. Here, each of the first terminal station 320 and the second terminal station 330 transmits a data packet to the satellite 310 over the satellite network 300. The relay of the satellite 310 merely amplifies an overlapping signal based on the data packets respectively transmitted from the first terminal station 320 and the second terminal station 330, and transmits back the overlapping signal to the first terminal station 320 and the second terminal station 330. That is, ‘A’ denotes a data packet transmitted from the first terminal station 320 to the satellite 310, and ‘B’ denotes a data packet transmitted from the second terminal station 330 to the satellite 310. The relay of the satellite 310 transmits A+B that is an overlapping signal of A and B to the first terminal station 320 and the second terminal station 330.

Further, when the reduced payload size and delayed transmission scheme according to the present invention is applied to analog network coding, one of the first data packet from the first terminal station 320 and the second data packet from the second terminal station 330 may be transmitted to be delayed or advanced (later or earlier). Further, since the payload size of each transmitted packet is reduced, the start and end portions of transmitted packets (spreading code portions) are received without interference, thus enabling more precise channel values to be estimated, with the result that data may be securely transmitted and received.

Meanwhile, based on the satellite 310, the direction in which signals are transmitted from the ground to the satellite 310 is called an uplink, and the direction in which signals are transmitted from the satellite 310 to the ground is called a downlink. That is, A and B are respectively transmitted to the satellite 310 through uplinks, and A+B is transmitted both to the first terminal station 320 and to the second terminal station 330 through downlinks.

Since the first terminal station 320 knows that data packet A, transmitted thereby, is included in the overlapping received signal A+B, it may decode data packet B transmitted from the second terminal station 330 by performing interference cancellation (IC) to eliminate the data packet A from the overlapping received signal A+B. Similarly, since the second terminal station 330 knows that the data packet B, transmitted thereby, is included in the overlapping received signal A+B, it may decode the data packet A transmitted from the first terminal station 320 by performing interference cancellation to eliminate the data packet B from the overlapping received signal A+B.

Although not shown in FIG. 3 in detail for convenience of illustration, the third terminal station 340 also receives the overlapping received signal A+B even in the slot in which analog network coding-based communication is performed. At this time, the third terminal station 340 may determine, using spreading codes (PN codes) present in the start and end portions of data packets, whether communication between the first terminal station 320 and the second terminal station 330 is performed or whether a collision between packets occurs in the slot.

Further, although an example in which analog network coding is applied to satellite communication has been illustrated in FIG. 3, the spirit of the present invention may be applied to all networks that employ a scheme for broadcasting signals received via a 2-way relay channel, that is, a relay node, to two terminal stations, without being limited to satellite communication networks.

Consequently, analog network coding is applied to a two-way relay channel, and is characterized in that an uplink channel and a downlink channel are separated around the relay. The communication method and apparatus using a slot-based channel according to the present invention may estimate slot-based channel values in real time so as to perform analog network coding in a single slot.

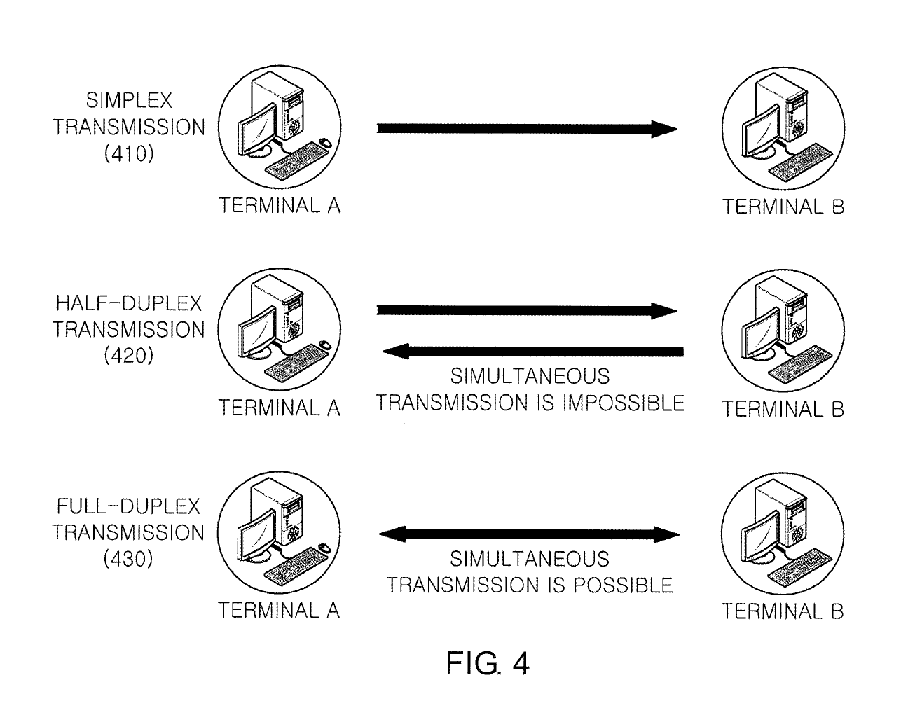

FIG. 4 is a conceptual diagram showing full-duplex communication to which communication technology using a slot-based channel according to an embodiment of the present invention can be applied.

In FIG. 4, schematic conceptual diagrams for simplex transmission, half-duplex transmission, and full-duplex transmission among transmission schemes in a network are illustrated. A brief description will be made below with reference to FIG. 4. First, link 410 illustrates a simplex transmission scheme, which enables transmission to be performed only in one direction. That is, terminal A enables only transmission and terminal B enables only reception. A representative example of simplex transmission may be a communication type in which a broadcasting station (terminal A) transmits signals and a radio or a television (terminal B) installed at home receives the signals.

Further, link 420 illustrates a half-duplex transmission scheme, wherein two communicating terminals are capable of transmitting data in both directions, but not simultaneously. That is, at any one time, transmission is possible only in one direction, and a collision may occur when two terminals simultaneously transmit data. In order to avoid such a collision, a terminal must transmit data after waiting for the data of a counterpart to be completely transmitted. A representative example of half-duplex transmission may be a communication type using a radio set.

Link 430 illustrates a full-duplex transmission (communication) scheme, wherein two communicating terminals are capable of simultaneously transmitting data in both directions. That is, transmission and reception may be simultaneously performed. In the case of a telephone, a user may hear the other party while speaking over the telephone, and thus a communication type using a telephone may be presented as a representative example of full-duplex communication.

Further, in the full-duplex communication scheme of link 430, a single-channel full-duplex communication scheme does not have a relay, unlike ANC, and exchanges information through a single channel without the distinction of links (i.e. in ANC, an uplink channel and a downlink channel are separated from each other, whereas, in full-duplex communication, the distinction of links is not present). In single-channel full-duplex communication, self-interference cancellation technology for allowing the terminal A to immediately eliminate a signal, transmitted thereby, through its own transmitter from a received signal at its own receiver is important. To perform self-interference cancellation in such a full-duplex communication scheme, it is important to acquire precise channel values. As described above, when full-duplex communication (or ANC communication) is performed in a TDMA-based system, wide areas of two signals overlap each other, so that a problem may arise in that the precision of channel values acquired from an overlapping signal having a wide overlap area is greatly deteriorated, and thus the performance of interference cancellation is also decreased.

Therefore, to estimate precise channel values when full-duplex communication or ANC is performed in a single slot, the present invention provides technology that allows the spreading code portions of data packets to be received without overlapping, by reducing the size of the payload of each transmitted data packet (reduced payload size) and by performing delayed transmission of the data packet, thus more precisely estimating slot-based channel values in real time.

Below, an operation flow of a communication method using a slot-based channel according to an embodiment of the present invention will be described in brief with reference to the above detailed description.

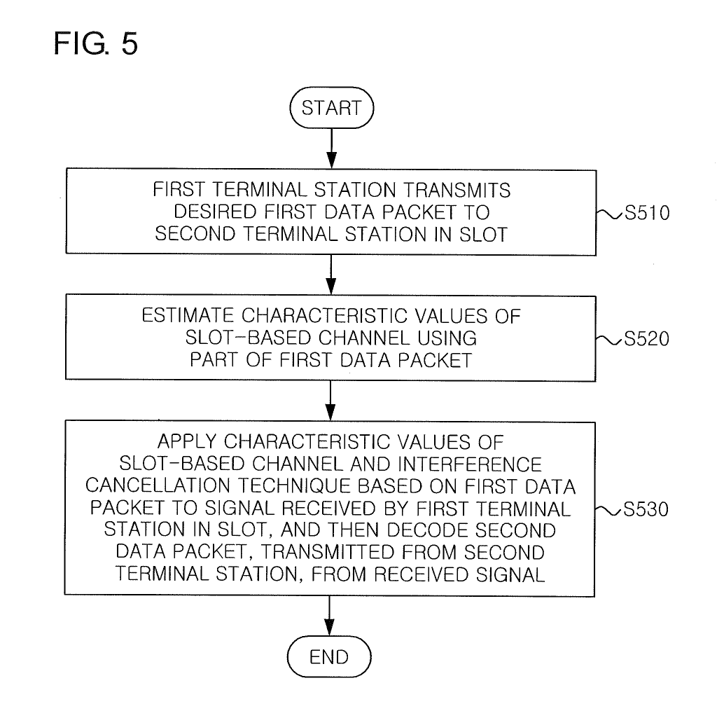

FIG. 5 is an operation flowchart showing a communication method using a slot-based channel according to an embodiment of the present invention.

Referring to FIG. 5, via the transmission unit 210 according to the present invention, the first terminal station transmits a desired first data packet to the second terminal station in a slot at step S510. In this case, the first data packet is a packet to which the technology of the present invention (i.e. technology related to reduced payload size and delayed transmission) is applied, and denotes a packet including a spreading code and a size-reduced payload.

Further, at step S510, the transmission unit 210 may generate part of the first data packet using a spreading code (corresponding to a PN code or a pseudo random noise code), and transmits a first data packet including the spreading code and the size-reduced payload to the second terminal station.

Furthermore, at step S510, in order for the first terminal station to receive the part of the first data packet (spreading code portion) without interference when the first terminal station transmits the desired first data packet to the second terminal station in the slot, the transmission unit 210 may transmit the first data packet earlier than a second data packet that is transmitted from the second terminal station, or later than the second data packet. That is, this technology means a delayed transmission technology proposed in the present invention.

Furthermore, at step S510, upon transmitting the first data packet, the transmission unit 210 may transmit the first data packet earlier or later than the second data packet transmitted from the second terminal station, by a time corresponding to the reduced payload size of the first data packet from a slot boundary.

In this regard, at step S510, the transmission unit 210 may determine which one of the first terminal station and the second terminal station will transmit a data packet later or earlier before ANC or full-duplex communication is performed. This may also be determined according to the preset sequence.

Furthermore, at step S510, in order for the first terminal station to receive part of the first data packet (spreading code portion) without interference, the transmission unit 210 may transmit the first data packet, with the payload size of the first data packet being reduced. That is, this means a reduced payload size technology proposed in the present invention.

Furthermore, at step S510, the transmission unit 210 may reduce the payload size of the first data packet by an amount corresponding to the sum of a preamble size and a guard time, and may transmit the first data packet, with a time synchronization error value being included in the size-reduced payload of the first data packet, wherein the reduced payload size of the first data packet may be a size of m-k-l symbols, as described above with reference to FIG. 1.

Meanwhile, since an example of packet transmission to which the reduced payload size and delayed transmission according to the embodiment of the present invention are applied has been described above with reference to FIG. 1, the description of FIG. 1 may be referred to.

Next, via the channel estimation unit 220, the characteristic values of a channel based on the slot (i.e. the slot in which the first data packet is transmitted via the transmission unit 210) are estimated using the part of the first data packet at step S520. Here, the part of the first data packet denotes a spreading code portion included in the start and end portions of the first data packet (corresponding to a preamble and postamble portion, a PN code portion or a keep-on sequence portion shown in FIG. 1), and the characteristic values of the slot-based channel may be estimated using the spreading code.

Next, via the decoding unit 230, the characteristic values of the slot-based channel and an interference cancellation technique based on the first data packet are applied to the signal received by the first terminal station in the slot (the slot in which the first data packet is transmitted via the transmission unit 210), and then the second data packet, transmitted from the second terminal station, is decoded from the received signal at step S530.

In other words, in the present invention, the first terminal station receives the signal transmitted from the second terminal station in the slot in which the first data packet has been transmitted via the transmission unit 210. At this time, the first terminal station receives an overlapping signal in which the signal transmitted thereby (i.e. the first data packet) and the signal transmitted from the second terminal station (i.e. the second data packet) overlap each other (the present invention may further include a reception unit (not shown) for allowing the first terminal station to receive the overlapping signal). Further, the decoding unit 230 may utilize the characteristic values of the slot-based channel estimated by the channel estimation unit 220 so as to perform interference cancellation in full-duplex communication or ANC, and may perform interference cancellation using the first data packet including a spreading code and a payload, especially using the payload. In this case, interference cancellation may be performed either using the entire portion of the first data packet (i.e. the spreading code and the payload portion), or using only the payload portion of the first data packet. Accordingly, the decoding unit 230 may decode the second data packet, transmitted from the second terminal station, from the signal that is received in the slot (i.e. the overlapping signal in which the signal transmitted from the first terminal station and the signal transmitted from the second terminal station overlap each other).

Further, when the decoding unit 230 cancels interference, the present invention may receive spreading codes (or preambles and postambles, or PN codes) required to estimate channel values of the transmitted two packets without overlapping (i.e. interference), estimate more precise channel values, and then expect further improved performance for interference cancellation, unlike the disadvantage of conventional packet transmission in that an overlapping portion between two packets is considerably wide and then the precision of channel estimation is deteriorated and the performance of interference cancellation is also decreased. By means of this advantage, the present invention may guarantee the stability of data transmission and the improvement of reception performance.

As described above, the present invention relates to a communication method and apparatus using a slot-based channel, and is advantageous in that slot-based channel values may be estimated in real time so as to perform ANC or full-duplex communication in a single slot.

The present invention is advantageous in that high channel usage efficiency can be guaranteed when applied to a satellite positioning/communication convergence system.

The present invention is advantageous in that the payload of a transmitted packet is reduced by a predetermined size, and a size-reduced packet is transmitted later or earlier (delayed transmission or advanced transmission), so that transmitted packets are received without the start and end portions of the transmitted packets overlapping each other, thus enabling more precise channel values to be estimated.

The present invention is advantageous in that a system requiring exact time synchronization such as a TDMA-based system may acquire real-time channel information for analog network coding and full-duplex communication.

The present invention may provide channel acquisition technology capable of performing analog network coding and full-duplex communication in a single channel, without requiring an additional channel for channel value acquisition.

Analog network coding is applied to a two-way relay channel, and is characterized in that an uplink channel and a downlink channel are separated with respect to a relay. Further, single-channel full-duplex communication is characterized in that information is exchanged through a single channel, without having a relay and the distinction of links. However, the present invention is advantageous in that it may be applied to different channel environments including analog network coding and single-channel full-duplex communication without separate correction, thus enabling precise channel values to be estimated in real time.

The present invention is advantageous in that the performance of channel value acquisition may be improved by means of a spreading code having a specific pattern (pseudo random noise code) included in the start and end portions of a transmitted packet.

The present invention was contrived based on research that was conducted under the support of the National Research Foundation of Korea and the Ministry of Science, ICT and Future Planning (MSIP) (national leading-challenge) [project management number: 2013R1A2A1A01016423; project title: positioning/communication convergence technology using aerospace node communication relay].

The communication method using a slot-based channel according to the embodiment of the present invention may be implemented in the form of program instructions that can be executed via various computer means, and may be stored in a computer-readable medium. The computer-readable medium may include one of program instructions, data files, and data structures or program instructions, data files, and data structures in combination. The program instructions recorded in the computer-readable medium may be program instructions that are specially designed and configured for the present invention or that are well known to and can be used by those having ordinary knowledge in the field of computer software. Examples of the computer-readable medium includes magnetic media such as a hard disk, a floppy disk and magnetic tape, optical media such as CD-ROM and a DVD, magneto-optical media such as a floptical disk, and hardware devices that are specially configured to store and execute program instructions, such as ROM, RAM, and flash memory. The examples of the program instructions include not only machine language code that is generated by a complier, but also high-level language that can be executed by a computer. The above-described hardware apparatus may be configured to operate as one or more software modules in order to perform the operation of the present invention, and vice versa.

Although the present invention has been described with reference to specific contents, such as detailed components, the above description is intended merely to help the overall understanding of the present invention, the present invention is not limited to the above embodiments, and those having ordinary knowledge in the technical field to which the present invention pertains can perform variations and modifications in various manners from the above description.

Accordingly, the spirit of the present invention should not be limited to the above-described embodiments, and the accompanying claims and equal or equivalent modifications thereof should be interpreted as falling within the range of the spirit and scope of the present invention.

What is claimed is:

1. A communication method using a slot-based channel, comprising:
transmitting a first data packet that is desired to be transmitted from a first terminal station to a second terminal station in a slot;
estimating characteristic values of a channel based on the slot using part of the first data packet; and
applying the characteristic values of the slot-based channel and an interference cancellation technique based on the first data packet to a signal received by the first terminal station in the slot, and then decoding, from the received signal, a second data packet that is transmitted from the second terminal station.

2. The communication method of claim 1, wherein estimating the characteristic values of the channel comprises:
estimating the characteristic values of the slot-based channel using part of the first data packet that is exclusively transmitted in the slot.

3. The communication method of claim 1, wherein transmitting the first data packet comprises:
in order for the first terminal station to receive the part of the first data packet without interference, transmitting the first data packet earlier or later than the second data packet that is transmitted from the second terminal station.

4. The communication method of claim 3, wherein transmitting the first data packet further comprises:
in order for the first terminal station to receive the part of the first data packet without interference, transmitting the first data packet, with a payload size of the first data packet being reduced.

5. The communication method of claim 4, wherein transmitting the first data packet further comprises:
reducing the payload size of the first data packet by an amount corresponding to a sum of a preamble size and a guard time, and transmitting the first data packet, with a time synchronization error value being included in the size-reduced payload.

6. The communication method of claim 4, wherein transmitting the first data packet further comprises:
transmitting the first data packet earlier or later than the second data packet that is transmitted from the second terminal station, by a time corresponding to the reduced payload size of the first data packet from a slot boundary.

7. The communication method of claim 1, wherein transmitting the first data packet comprises:
generating the part of the first data packet using a spreading code (pseudo random noise code).

8. A communication apparatus using a slot-based channel, comprising a processor configured to:
transmit a first data packet that is desired to be transmitted from a first terminal station to a second terminal station in a slot;
estimate characteristic values of a channel based on the slot using part of the first data packet;
apply the characteristic values of the slot-based channel and an interference cancellation technique based on the first data packet to a signal received by the first terminal station in the slot; and
decode, from the received signal, a second data packet that is transmitted from the second terminal station.

9. The communication apparatus of claim 8, wherein the processor is configured to estimate the characteristic values of the slot-based channel using part of the first data packet that is exclusively transmitted in the slot.

10. The communication apparatus of claim 8, wherein the processor is configured to, in order for the first terminal station to receive the part of the first data packet without interference, transmit the first data packet earlier or later than the second data packet that is transmitted from the second terminal station.

11. The communication apparatus of claim 10, wherein the processor is configured to, in order for the first terminal station to receive the part of the first data packet without interference, transmit the first data packet, with a payload size of the first data packet being reduced.

12. The communication apparatus of claim 11, wherein the processor is configured to reduce the payload size of the first data packet by an amount corresponding to a sum of a preamble size and a guard time, and transmits the first data packet, with a time synchronization error value being included in the size-reduced payload.

13. The communication apparatus of claim 11, wherein the processor is configured to transmit the first data packet earlier or later than the second data packet that is transmitted from the second terminal station, by a time corresponding to the reduced payload size of the first data packet from a slot boundary.

14. The communication apparatus of claim 8, wherein the processor is configured to generate the part of the first data packet using a spreading code or pseudo random noise code.
